(19) United States
(12) Patent Application Publication
(10) Pub. No.: US 2019/0057328 A1
(43) Pub. Date: Feb. 21, 2019

(54) RESERVATION MANAGEMENT APPARATUS, RESERVATION MANAGEMENT METHOD, AND COMPUTER READABLE MEDIUM

(71) Applicant: MITSUBISHI ELECTRIC CORPORATION, Tokyo (JP)

(72) Inventor: Takao YONETA, Tokyo (JP)

(73) Assignee: MITSUBISHI ELECTRIC CORPORATION, Tokyo (JP)

(21) Appl. No.: 16/079,040

(22) PCT Filed: Apr. 27, 2016
(86) PCT No.: PCT/JP2016/063256

§ 371 Date: Aug. 22, 2018

(51) Int. Cl. G06Q 10/02; G06Q 30/02

(52) U.S. Cl. CPC G06Q 10/02; G06Q 30/0208

(57) ABSTRACT

A plan devisal unit (320) generates a plan for provision of a service to a reserver, using an approved condition that is a service provision condition approved at the time of reservation by the reserver of the service. A coordination details generation unit (330) generates an alternate condition that is a service provision condition not approved at the time of the reservation by the reserver, more disadvantageous to the reserver than the approved condition, and more advantageous to a service provider than the approved condition, together with a reward that is given to the reserver if the reserver accepts the alternate condition. The plan devisal unit (320) updates the plan for the provision of the service to the reserver using the alternate condition if a response of intent to accept the alternate condition and the reward is obtained from the reserver as a result of making a query about whether the reserver accepts the alternate condition and the reward.

### TECHNICAL FIELD

The present invention relates to a reservation management apparatus, a reservation management method, and a reservation management program.

### BACKGROUND ART

Patent Literature 1 discloses a method for increasing benefits to a reserver and a business operator, in which each reserver designates a time desired to be finalized at the time of reservation of a service, and provisional reservations are exchanged between reservers by times desired to be finalized.

### CITATION LIST

### Patent Literature

Patent Literature 1: JP 4406684

### SUMMARY OF INVENTION

### Technical Problem

A service provider (hereinafter also referred to as a business operator) desires to devise a most appropriate service provision plan in terms of the economics of the service provider itself while meeting needs of a reserver (hereinafter also referred to as a user). However, if a plurality of users reserve a service on demand, the status of reservation changes from moment to moment, and a most appropriate service provision plan for the service provider changes. For example, a transport service, such as an on-demand car service, can reduce the operational cost by transporting users going in the same direction together through ride sharing. A user may desire ride sharing if the user can receive a discount by accepting ride sharing.

In a general reservation system, however, a service provision plan is finalized at the time of reservation. This causes the problem of the incapability to change the service provision plan later.

The technique according to Patent Literature 1 is capable of changing a service provision plan after reservation, but there is a problem of the incapability to change a service provision plan using a service provision condition not approved at the time of reservation by a reserver.

One of main objects of the present invention is to solve the above-described problem. That is, the present invention mainly aims to change a service provision plan using a service provision condition not approved at the time of reservation by a reserver, increase the satisfaction level of the reserver, and increase profit of a business operator.

### Solution to Problem

A reservation management apparatus according to the present invention includes:

a plan generation unit to generate a plan for provision of a service to a reserver, using an approved condition that is a service provision condition approved at the time of reservation by the reserver of the service;

a condition generation unit to generate an alternate condition that is a service provision condition not approved at the time of the reservation by the reserver, more disadvantageous to the reserver than the approved condition, and more advantageous to a service provider than the approved condition, together with a reward that is given to the reserver if the reserver accepts the alternate condition; and

a plan updating unit to update the plan for the provision of the service to the reserver using the alternate condition if a response of intent to accept the alternate condition and the reward is obtained from the reserver as a result of making a query about whether the reserver accepts the alternate condition and the reward.

### Advantageous Effects of Invention

According to the present invention, an alternate condition is generated together with a reward, the alternate condition being a service provision condition not approved at the time of reservation by a reserver, more disadvantageous to the reserver than an approved condition, and more advantageous to a service provider than the approved condition. Additionally, in the present invention, a plan for provision of a service to the reserver is updated using the alternate condition if a response of intent to accept the alternate condition and the reward is obtained from the reserver. Therefore, the present invention allows a change of a service provision plan using a service provision condition not approved at the time of reservation by a reserver. It is thus possible to increase the satisfaction level of a reserver and increase profit of a business operator.

### BRIEF DESCRIPTION OF DRAWINGS

FIG. 1 illustrates an example of a configuration of a reservation system according to Embodiment 1.

FIG. 2 illustrates an example of a hardware configuration of a reservation apparatus according to Embodiment 1.

FIG. 3 illustrates an example of a hardware configuration of a reservation management apparatus according to Embodiment 1.

FIG. 4 illustrates an example of a functional configuration of the reservation apparatus according to Embodiment 1.

FIG. 5 illustrates an example of a functional configuration of the reservation management apparatus according to Embodiment 1.

FIG. 6 is a flowchart illustrating an example of an operation of the reservation management apparatus according to Embodiment 1.

FIG. 7 is a flowchart illustrating details of a reservation reception process according to Embodiment 1.

FIG. 8 is a flowchart illustrating details of a coordination response reception process according to Embodiment 1.

FIG. 9 is a flowchart illustrating details of a plan devisal process according to Embodiment 1.

FIG. 10 is a flowchart illustrating details of a plan finalization process according to Embodiment 1.

FIG. 11 is a flowchart illustrating details of a coordination details generation process according to Embodiment 1.

FIG. 12 is a flowchart illustrating details of an eased condition generation process according to Embodiment 1.

FIG. 13 is a flowchart illustrating the details of the eased condition generation process according to Embodiment 1.

FIG. 14 illustrates an example of a reservation management table according to Embodiment 1.

FIG. 15 illustrates an example of an operation plan management table according to Embodiment 1.

FIG. 16 illustrates an example of a condition management table according to Embodiment 1.

FIG. 17 illustrates an example of a condition code table according to Embodiment 1.

FIG. 18 illustrates an example of a coordination management table according to Embodiment 1.

FIG. 19 illustrates an example of a coordination success rate management table according to Embodiment 1.

FIG. 20 illustrates an example of a reservation management table after updating according to Embodiment 1.

FIG. 21 illustrates an example of an operation plan management table after updating according to Embodiment 1.

FIG. 22 illustrates an example of a reservation condition management table after updating according to Embodiment 1.

### DESCRIPTION OF EMBODIMENTS

### Embodiment 1

### Description of Configuration

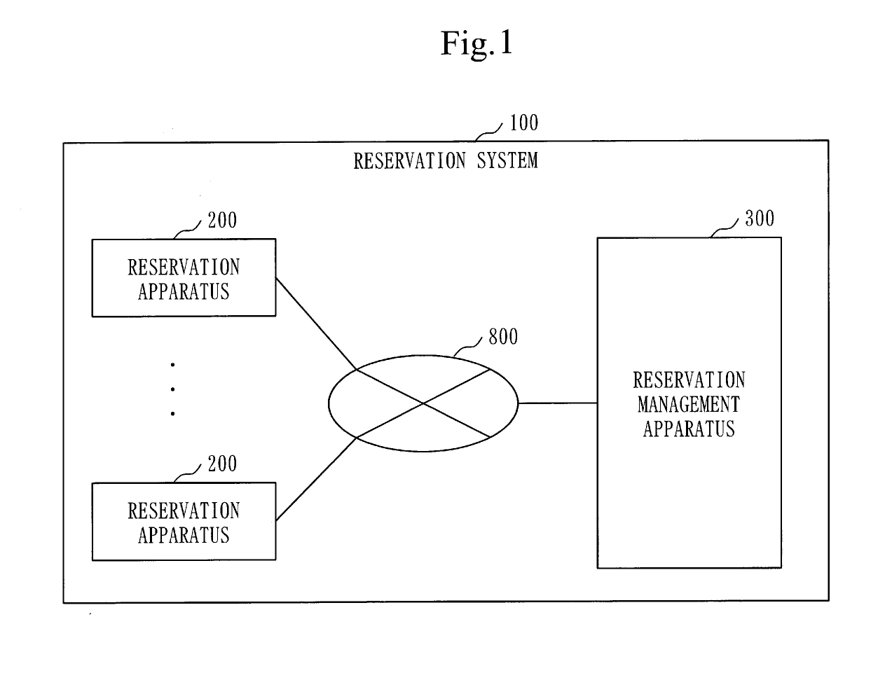

FIG. 1 illustrates an example of a configuration of a reservation system 100 according to the present embodiment.

In the reservation system 100, a plurality of reservation apparatuses 200 and a reservation management apparatus 300 are connected over a network 800.

The reservation apparatus 200 is a computer used by a user of a service to reserve the service. Note that a user will hereinafter also be referred to as a reserver.

The reservation management apparatus 300 is a computer which accepts a reservation. An operation performed by the reservation management apparatus 300 corresponds to an example of a reservation management method.

In the reservation system 100 according to the present embodiment, a user reserves a service on demand using the reservation apparatus 200, and the reservation management apparatus 300 generates a plan for provision of the service in accordance with the status of reservation. A description will be given below, taking as an example a transport service, such as an on-demand car service.

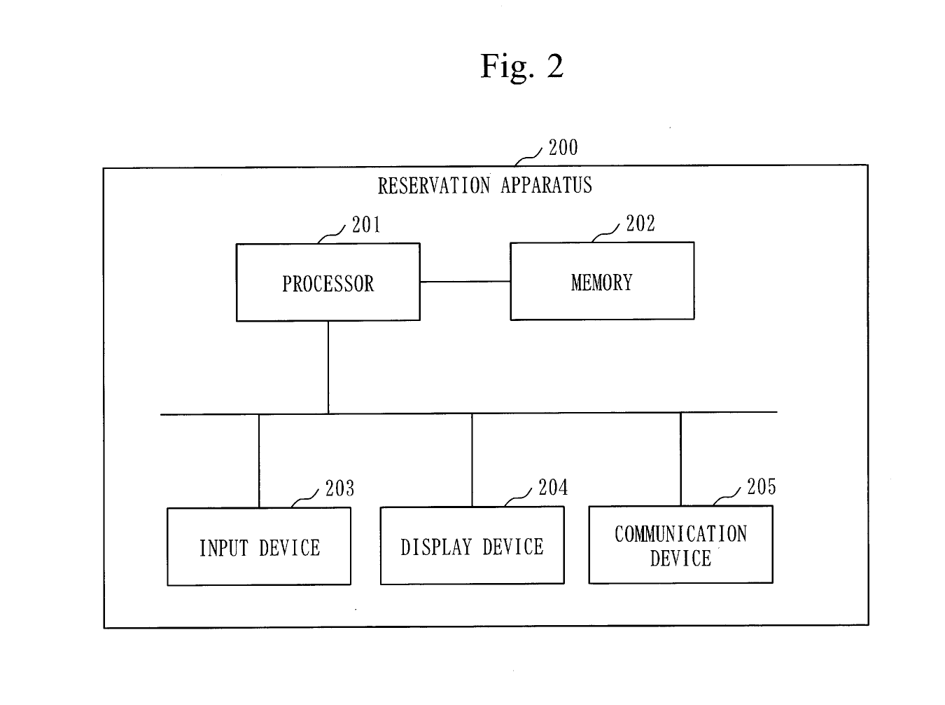

FIG. 2 illustrates an example of the hardware configuration of the reservation apparatus 200.

As illustrated in FIG. 2, the reservation apparatus 200 includes, as pieces of hardware, a processor 201, a memory 202, an input device 203, a display device 204, and a communication device 205.

The processor 201 is a circuit which performs computing. The processor 201 executes a program which implements functions of a reservation transmission unit 210, a reservation change result reception unit 220, a coordination request reception unit 230, and a coordination response transmission unit 240, which will be described later. Specifically, the processor 201 is a CPU (Central Processing Unit).

The memory 202 stores information needed for computing. The memory 202 also stores the program that implements the functions of the reservation transmission unit 210, the reservation change result reception unit 220, the coordination request reception unit 230, and the coordination response transmission unit 240. Specifically, the memory 202 is a RAM (Random Access Memory).

The input device 203 is used by a user to input details of a reservation to the reservation apparatus 200. The input device 203 is an interface, such as a keyboard or a mouse.

The display device 204 displays a reservation entry screen, a reservation result screen, and the like. The display device 204 is an interface with a display.

The communication device 205 is a circuit which communicates with the reservation management apparatus 300. Specifically, the communication device 205 is a communication chip or an NIC (Network Interface Card).

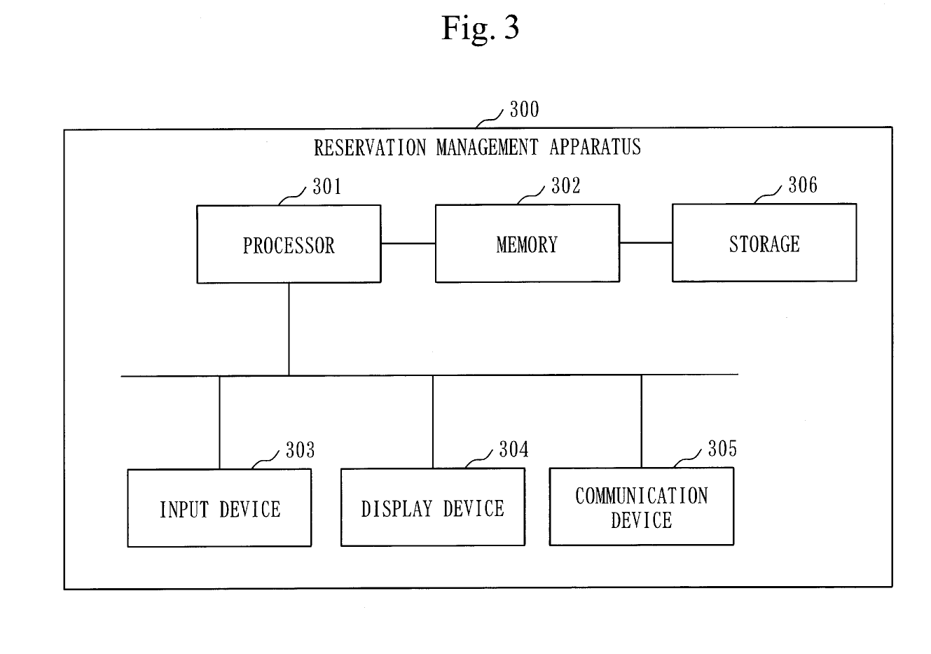

FIG. 3 illustrates an example of the hardware configuration of the reservation management apparatus 300.

As illustrated in FIG. 3, the reservation management apparatus 300 includes, as pieces of hardware, a processor 301, a memory 302, an input device 303, a display device 304, a communication device 305, and a storage 306.

The processor 301 is a circuit which performs computing. The processor 301 executes a program which implements functions of a reservation management control unit 310, a reservation reception unit 311, a plan devisal unit 320, a plan finalization unit 321, a coordination details generation unit 330, a coordination request transmission unit 350, and a coordination response reception unit 360, which will be described later. Of the program, a program which implements the functions of the plan devisal unit 320 and the coordination details generation unit 330 corresponds to a reservation management program. Specifically, the processor 301 is a CPU.

The memory 302 stores information needed for computing. The program that implements the functions of the reservation management control unit 310, the reservation reception unit 311, the plan devisal unit 320, the plan finalization unit 321, the coordination details generation unit 330, the coordination request transmission unit 350, and the coordination response reception unit 360 is loaded into the memory 302. Specifically, the memory 302 is a RAM.

The storage 306 accumulates a great deal of information. The storage 306 also stores the program that implements the functions of the reservation management control unit 310, the reservation reception unit 311, the plan devisal unit 320, the plan finalization unit 321, the coordination details generation unit 330, the coordination request transmission unit 350, and the coordination response reception unit 360. Specifically, the storage 306 is a flash memory or an HDD (Hard Disk Drive).

An OS (Operating System) is also stored in the storage 306. At least a part of the OS is executed by the processor 301. The processor 301 executes the program that implements the functions of the reservation management control unit 310, the reservation reception unit 311, the plan devisal unit 320, the plan finalization unit 321, the coordination details generation unit 330, the coordination request transmission unit 350, and the coordination response reception unit 360 while executing at least the part of the OS.

Task management, memory management, file management, communication control, and the like are performed through the execution of the OS by the processor 301.

The program that implements the functions of the reservation management control unit 310, the reservation reception unit 311, the plan devisal unit 320, the plan finalization unit 321, the coordination details generation unit 330, the coordination request transmission unit 350, and the coordination response reception unit 360 may be stored in a portable storage medium, such as a magnetic disk, a flexible disk, an optical disc, a compact disc, a Blu-ray (a registered trademark) disc, or a DVD.

The input device 303 is used by an operator of the reservation management apparatus 300 to input various types of instructions to the reservation management apparatus 300.

The display device 304 displays various types of information to the operator of the reservation management apparatus 300.

The communication device 305 is a circuit which communicates with the reservation apparatus 200.

The reservation management apparatus 300 may be implemented by an electronic circuit, such as a logic IC (Integrated Circuit), a GA (Gate Array), an ASIC (Application Specific Integrated Circuit), or an FPGA (Field-Programmable Gate Array).

Note that the processor 301 and the above-described electronic circuits are also collectively referred to as processing circuitry.

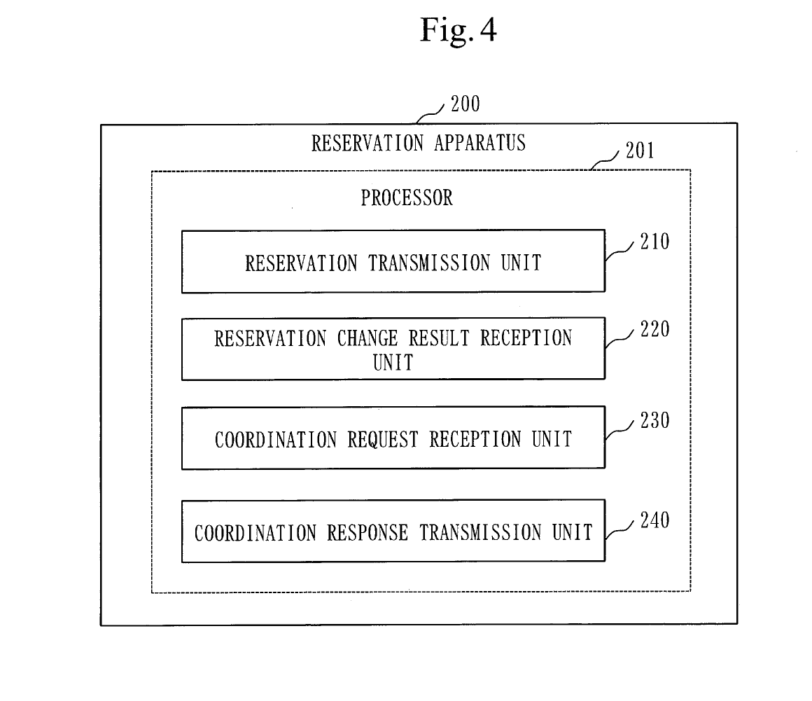

FIG. 4 illustrates an example of the functional configuration of the reservation apparatus 200.

As illustrated in FIG. 4, the reservation apparatus 200 includes the reservation transmission unit 210, the reservation change result reception unit 220, the coordination request reception unit 230, and the coordination response transmission unit 240.

The reservation transmission unit 210 transmits reservation data to the reservation management apparatus 300. The reservation data describes a user number, a departure point code, a destination code, a desired start time, and a desired arrival time. The user number is an identifier which allows unique identification of a user of the reservation apparatus 200. The departure point code is an identifier which allows unique identification of a departure point desired by the user. The destination code is an identifier which allows unique identification of a destination desired by the user. The desired departure time is a departure time desired by the user. The desired arrival time is an arrival time desired by the user.

The departure point code, the destination code, the desired departure time, and the desired arrival time are conditions (service provision conditions) for providing the transport service. Additionally, the departure point code, the destination code, the desired departure time, and the desired arrival time are service provision conditions designated at the time of reservation by a reserver and will be referred to as reservation conditions.

The reservation data may also describe an approved condition. The approved condition is a condition approved at the time of the reservation by the reserver, which is more disadvantageous to the reserver than a corresponding one of the reservation conditions, and which is more advantageous to a business operator. The approved condition may be held in advance in the reservation management apparatus 300. If the approved condition is held in the reservation management apparatus 300, the reservation data need not describe the approved condition.

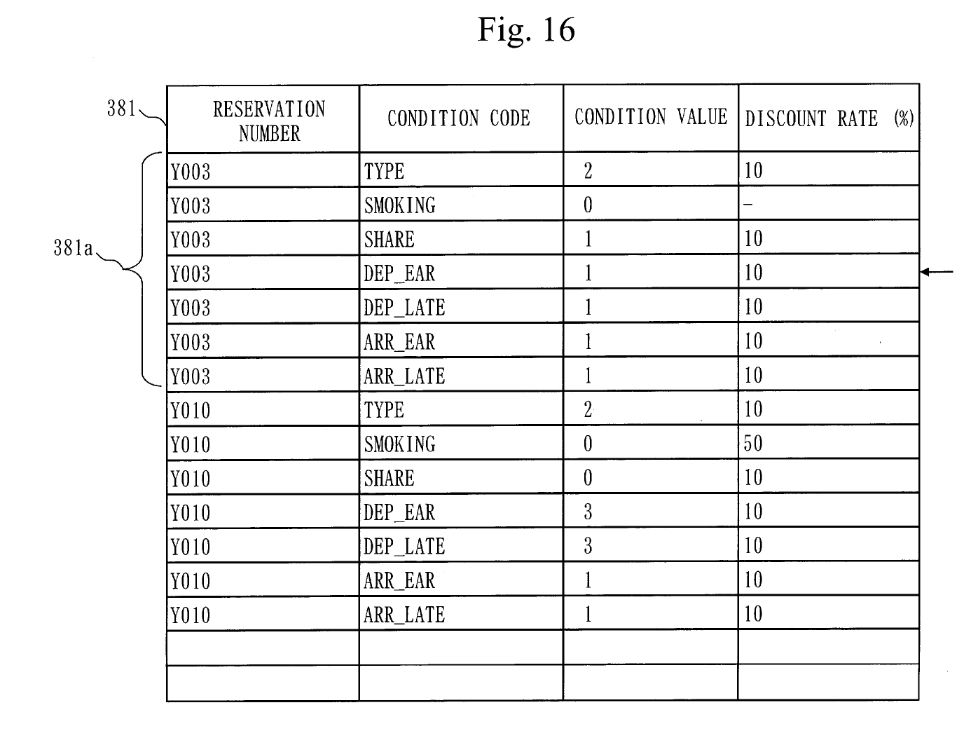

Note that each condition is composed of a condition code and a condition value. As will be described later, a condition management table 381 in FIG. 16 lists approved conditions. That is, each approved condition in FIG. 16 is composed of a “condition code” (for example, “TYPE”) and an “approved condition value” (for example, [2]). A given condition may be expressed as being larger/smaller than a different condition in the following description. The expression “a given condition (for example, condition A) is larger/smaller than a different condition (for example, condition B)” means that a condition code of condition A and a condition code of condition B are the same and that a condition value of condition A is larger/smaller than a condition value of condition B.

The reservation change result reception unit 220 receives changed reservation notification data from the reservation management apparatus 300. The changed reservation notification data is data which gives notice of a changed reservation after a reservation change in the reservation management apparatus 300.

The coordination request reception unit 230 receives coordination request data from the reservation management apparatus 300. The coordination request data describes an alternate condition. The alternate condition is a service provision condition not approved at the time of the reservation by the reserver. The alternate condition is more disadvantageous to the reserver than a corresponding reservation condition or approved condition, and is more advantageous to the service provider. The coordination request data also describes a reward which is given to the reserver if the reserver accepts the alternate condition. The coordination request data is data for querying whether the alternate condition and the reward are accepted.

The coordination response transmission unit 240 transmits coordination response data to the reservation management apparatus 300. The coordination response data is data for notifying the reservation management apparatus 300 whether the reserver has accepted the alternate condition and the reward.

As described earlier, the reservation transmission unit 210, the reservation change result reception unit 220, the coordination request reception unit 230, and the coordination response transmission unit 240 are implemented by the program, and the program that implements the reservation transmission unit 210, the reservation change result reception unit 220, the coordination request reception unit 230, and the coordination response transmission unit 240 is executed by the processor 201.

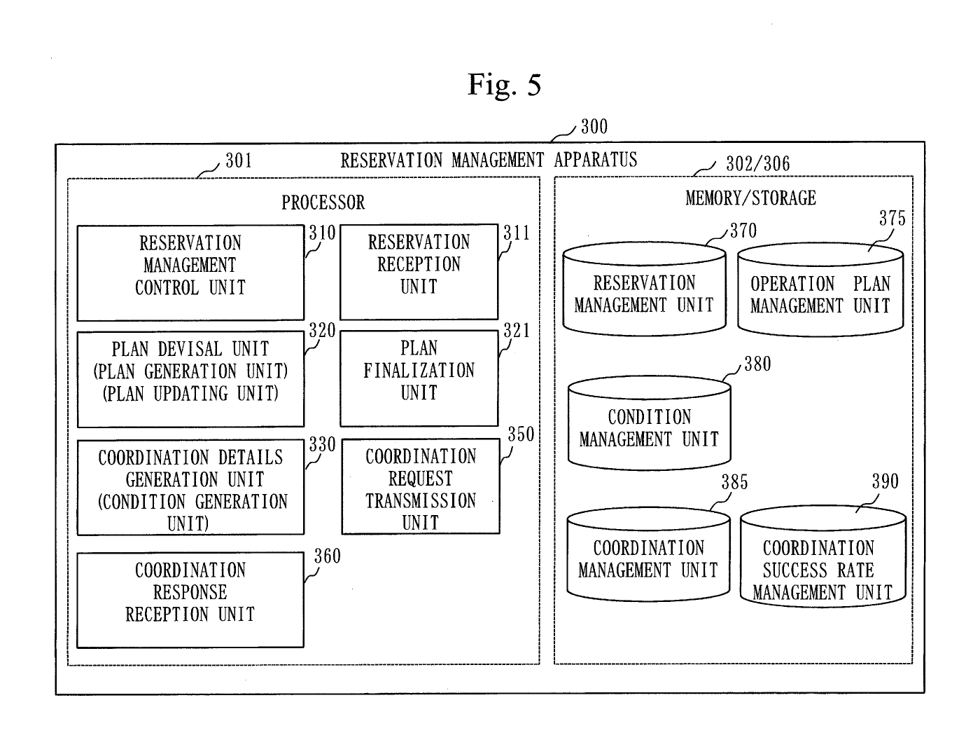

FIG. 5 illustrates an example of the functional configuration of the reservation management apparatus 300.

As illustrated in FIG. 5, the reservation management apparatus 300 includes the reservation management control unit 310, the reservation reception unit 311, the plan devisal unit 320, the plan finalization unit 321, the coordination details generation unit 330, the coordination request transmission unit 350, the coordination response reception unit 360, a reservation management unit 370, an operation plan management unit 375, a condition management unit 380, a coordination management unit 385, and a coordination success rate management unit 390.

The reservation management control unit 310 controls the reservation reception unit 311, the plan devisal unit 320, the plan finalization unit 321, the coordination details generation unit 330, the coordination request transmission unit 350, and the coordination response reception unit 360.

The reservation reception unit 311 receives reservation data transmitted from the reservation apparatus 200.

The plan devisal unit 320 devises a plan for provision of the service.

More specifically, the plan devisal unit 320 generates a plan for provision of the service to a reserver using reservation conditions and approved conditions. The plan devisal unit 320 updates the plan for the provision of the service to the reserver using an alternate condition if a response of intent to accept the alternate condition and a reward is obtained from the reserver.

The plan devisal unit 320 corresponds to a plan generation unit and a plan updating unit. An operation performed by the plan devisal unit 320 corresponds to a plan generation process and a plan updating process.

The coordination details generation unit 330 generates an alternate condition and a reward which is given to a reserver if the reserver accepts the alternate condition.

Specifically, the coordination details generation unit 330 generates the alternate condition on the basis of a past experiential condition which is a service provision condition, about which the reserver has previously been queried. For example, the coordination details generation unit 330 refers to a coordination success rate management table 391 (an example of past experiential condition information) which is stored in the coordination success rate management unit 390, which will be described later, and selects a past experiential condition, a success rate for which is not less than a threshold and which is most advantageous to the business operator, from among a plurality of past experiential conditions. The coordination success rate management table 391 describes the plurality of past experiential conditions and a success rate for a response to a query addressed to the reserver for each of the plurality of past experiential conditions. The coordination details generation unit 330 may use the selected past experiential condition selected as the alternate condition without change or may generate, as the alternate condition, a service provision condition more disadvantageous to the reserver and more advantageous to the service provider than the selected past experiential condition.

The coordination details generation unit 330 corresponds to a condition generation unit. An operation performed by the coordination details generation unit 330 corresponds to a condition generation process.

The coordination request transmission unit 350 transmits coordination request data to the reservation apparatus 200.

The coordination response reception unit 360 receives coordination response data from the reservation apparatus 200.

As described earlier, the reservation management control unit 310, the reservation reception unit 311, the plan devisal unit 320, the plan finalization unit 321, the coordination details generation unit 330, the coordination request transmission unit 350, and the coordination response reception unit 360 are implemented by the program. The program is executed by the processor 301.

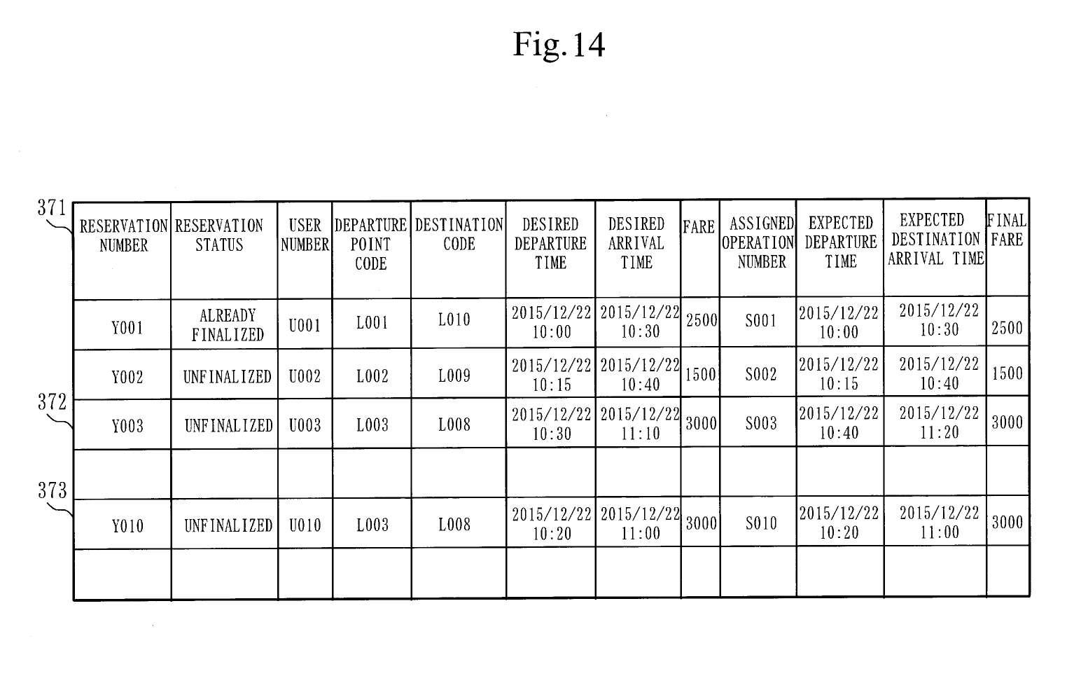

The reservation management unit 370 stores a reservation management table 371. The reservation management table 371 is a table illustrated in FIG. 14. Details of the reservation management table 371 will be described later.

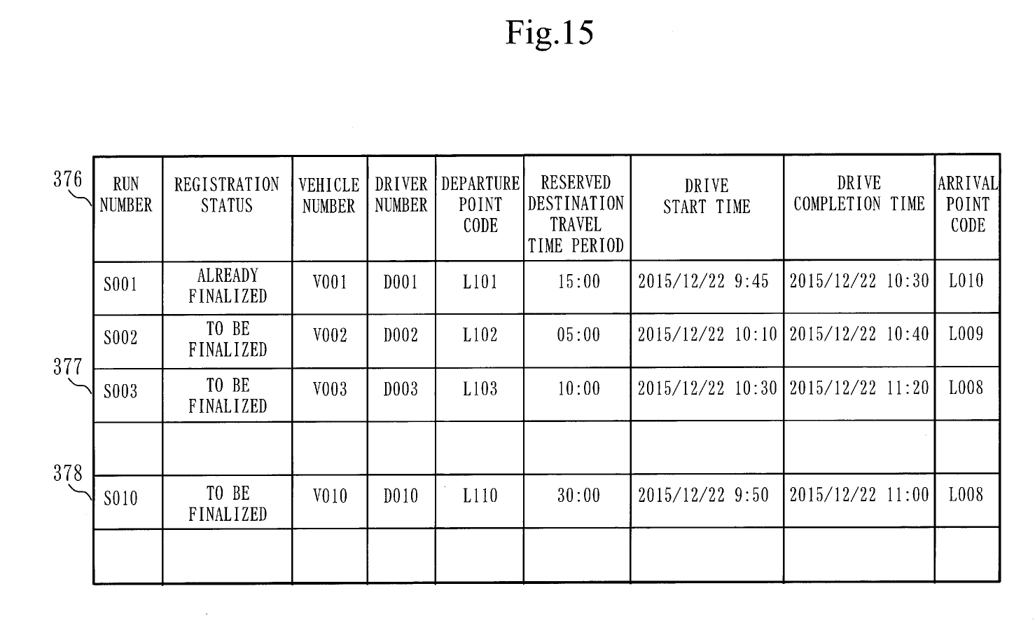

The operation plan management unit 375 stores an operation plan management table 376. The operation plan management table 376 is a table illustrated in FIG. 15. Details of the operation plan management table 376 will be described later.

The condition management unit 380 stores the condition management table 381. The condition management table 381 is a table illustrated in FIG. 16. Details of the condition management table 381 will be described later.

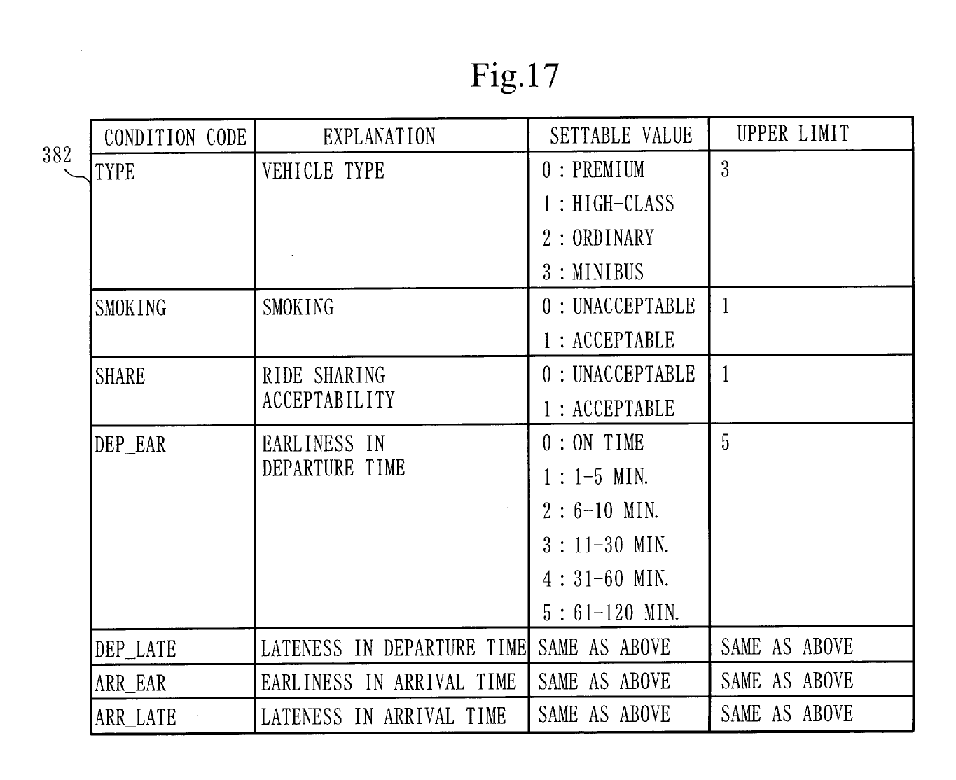

The condition management unit 380 also stores a condition code table 382. The condition code table 382 is a table illustrated in FIG. 17. Details of the condition code table 382 will be described later.

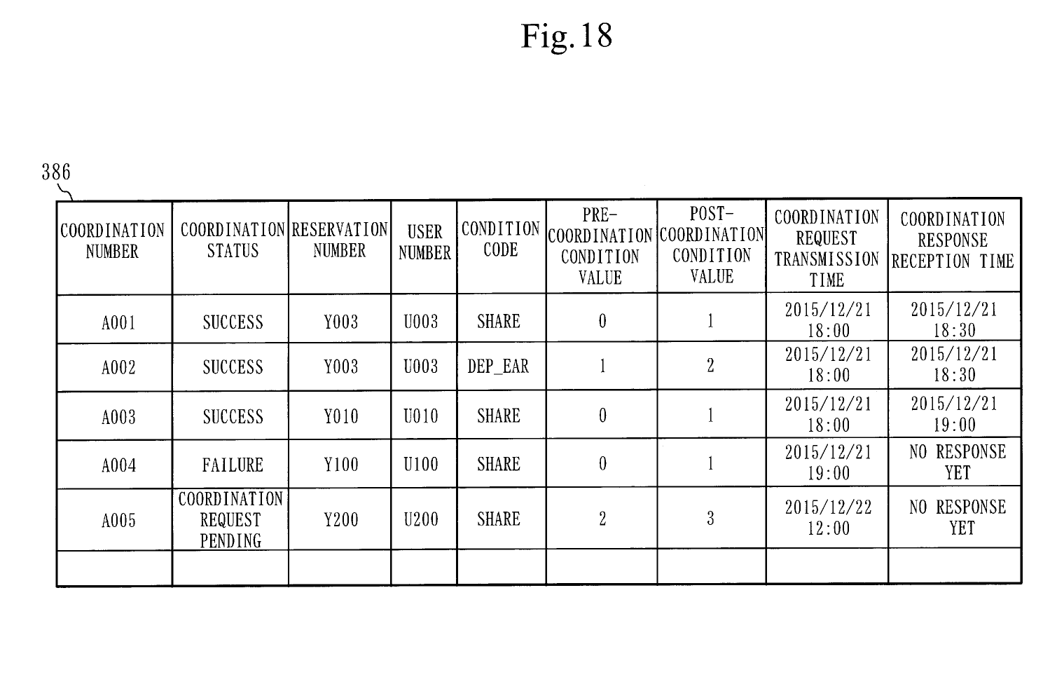

The coordination management unit 385 stores a coordination management table 386. The coordination management table 386 is a table illustrated in FIG. 18. Details of the coordination management table 386 will be described later.

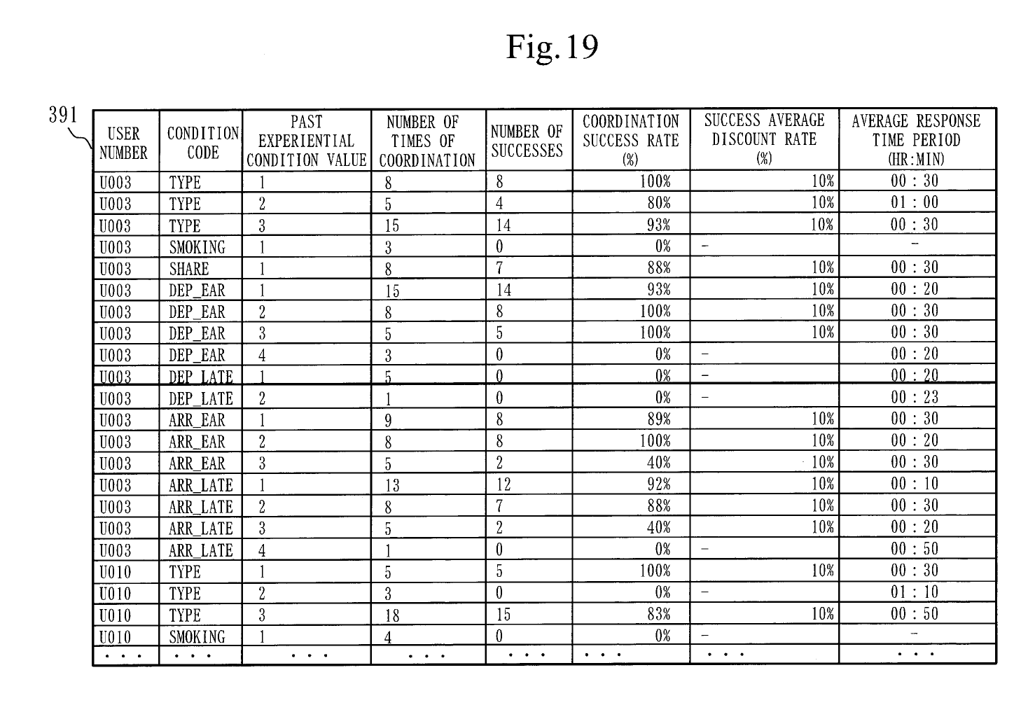

The coordination success rate management unit 390 stores the coordination success rate management table 391. The coordination success rate management table 391 is a table illustrated in FIG. 19. Details of the coordination success rate management table 391 will be described later.

The reservation management unit 370, the operation plan management unit 375, the condition management unit 380, the coordination management unit 385, and the coordination success rate management unit 390 are implemented by the memory 302 or the storage 306 illustrated in FIG. 3.

FIG. 14 illustrates an example of the reservation management table 371.

In FIG. 14, an identifier (a reservation number) for unique identification of a reservation is stored in the “RESERVATION NUMBER” column.

A value for determining whether the reservation is finalized is stored in the “RESERVATION STATUS” column.

A user number which is a number for unique identification of a reserver is stored in the “USER NUMBER” column.

A code (a departure point code) of a departure point is stored in the “DEPARTURE POINT CODE” column.

A code (a destination code) of a destination is stored in the “DESTINATION CODE” column. The departure point code and the destination code can each be expressed as X and Y coordinates or the like.

A time (a desired departure time) at which the reserver desires a vehicle to depart from the departure point is stored in the “DESIRED DEPARTURE TIME” column.

A time (a desired arrival time) at which the reserver desires the vehicle to arrive at the destination is stored in the “DESIRED ARRIVAL TIME” column.

A fare tentatively determined at the time of reservation is stored in the “FARE” column.

A number corresponding to an operation number in the operation plan table 376 is stored in the “ASSIGNED OPERATION NUMBER” column.

An expected time which is finally determined as a result of coordination and at which the vehicle is to depart from the departure point is stored in the “EXPECTED DEPARTURE TIME” column. The desired departure time is stored in “EXPECTED DEPARTURE TIME” in a phase without coordination.

An expected time (an expected destination arrival time) which is finally determined as the result of the coordination and at which the vehicle is to arrive at the destination is stored in the “EXPECTED DESTINATION ARRIVAL TIME” column. The desired arrival time is stored in “EXPECTED DESTINATION ARRIVAL TIME” in the phase without coordination.

A fare which is finally determined as the result of the coordination is stored in the “FINAL FARE” column. If the fare is discounted at the time of the coordination, the discounted fare is stored in “FINAL FARE”.

FIG. 15 illustrates an example of the operation plan management table 376.

In FIG. 15, an identifier (an operation number) for unique identification of a vehicle operation is stored in the “OPERATION NUMBER” column.

A value for determining whether the operation is finalized is stored in the “REGISTRATION STATUS” column.

A number (a vehicle number) of a vehicle to be used is stored in the “VEHICLE NUMBER” column.

A number (a driver number) of a driver who drives the vehicle is stored in the “DRIVER NUMBER” column.

A code (a departure point code) of a departure point is stored in the “DEPARTURE POINT CODE” column.

A time period (a reserved destination travel time period) required for reserved travel from the departure point to a destination is stored in the “RESERVED DESTINATION TRAVEL TIME PERIOD” column.

A time (a drive start time) at which the driver needs to start driving the vehicle is stored in the “DRIVE START TIME” column.

A time (a drive completion time) at which the driver is to complete driving the vehicle is stored in the “DRIVE COMPLETION TIME” column.

A code (an arrival point code) of an arrival point at which the driver has completed driving the vehicle is stored in the “ARRIVAL POINT CODE” column.

FIG. 16 illustrates an example of the condition management table 381.

In FIG. 16, a reservation number which is described in the reservation management table 371 (FIG. 14) is stored in the “RESERVATION NUMBER” column.

A code (a condition code) for unique identification of a condition is stored in the “CONDITION CODE” column. More specifically, a condition code which is described in the condition code table 382 (FIG. 17) is stored in the “CONDITION CODE” column.

A value (a condition value) of the condition is stored in the “CONDITION VALUE” column. More specifically, any one of “settable values” in the condition code table 382 (FIG. 17) is stored in the “CONDITION VALUE” column.

A discount rate which applies to a case where a reservation is finalized with the condition value shown in “CONDITION VALUE” is stored in the “DISCOUNT RATE” column.

FIG. 17 illustrates an example of the condition code table 382.

In FIG. 17, a code (a condition code) for unique identification of a reservation condition is stored in the “CONDITION CODE” column.

An upper limit for a condition value which is settable for the corresponding condition code is stored in the “UPPER LIMIT” column. Each of the “EXPLANATION” column and the “SETTABLE VALUE” column has a description for explanation. In the operation of the reservation management apparatus 300, the “EXPLANATION” column and the “SETTABLE VALUE” column are not necessary.

FIG. 18 illustrates an example of the coordination management table 386.

In FIG. 18, an identifier (a coordination number) for unique identification of coordination details is stored in the “COORDINATION NUMBER” column.

A value indicating the status of coordination is stored in the “COORDINATION STATUS” column.

A reservation number of a reservation to be coordinated is stored in the “RESERVATION NUMBER” column.

A user number of a user to be coordinated is stored in the “USER NUMBER” column.

A condition code of the reservation to be coordinated is stored in the “CONDITION CODE” column.

A condition value before the coordination is stored in the “PRE-COORDINATION CONDITION VALUE” column.

A condition value after the coordination is stored in the “POST-COORDINATION CONDITION VALUE” column.

A time of transmission of coordination request data to the reservation apparatus 200 is stored in the “COORDINATION REQUEST TRANSMISSION TIME” column.

A time of reception of coordination response data from the reservation apparatus 200 is stored in the “COORDINATION RESPONSE RECEPTION TIME” column.

FIG. 19 illustrates an example of the coordination success rate management table 391.

In FIG. 19, a number (a user number) for unique identification of a reserver is stored in the “USER NUMBER” column.

A condition code which is described in the condition code table 382 is stored in the “CONDITION CODE” column.

A condition value, about which the user has previously been queried, is stored in the “PAST EXPERIENTIAL CONDITION VALUE” column.

The number of times the user has been queried is stored in the “NUMBER OF TIMES OF COORDINATION” column.

The number of successes in coordination is stored in the “NUMBER OF SUCCESSES” column.

A rate (a coordination success rate) at which coordination has previously been successful is stored in the “COORDINATION SUCCESS RATE” column. The coordination success rate is obtained by “the number of successes”/“the number of times of coordination”×100.

An average value of discount rates for successful coordination is stored in the “SUCCESS AVERAGE DISCOUNT RATE” column.

An average value of time periods required from transmission of coordination request data to reception of coordination response data is stored in the “AVERAGE RESPONSE TIME PERIOD” column.

### Description of Operation

The operation of the reservation apparatus 200 and the reservation management apparatus 300 will next be described.

Transmission of reservation data by the reservation apparatus 200 will be described first.

A user inputs a user number of U003 of the user and reservation conditions, using the input device 203 of the reservation apparatus 200.

The user inputs, for example, the following reservation conditions:

Departure point code: L003

Destination code: L008

Desired departure time: 2015/12/22 10:30

Desired arrival time: 2015/12/22 11:10

The user may use GPS (Global Positioning System) information and the like as each of a departure point code and a destination code. The user may also use a code value obtained through conversion from GPS information.

The user may also input approved conditions to the reservation apparatus 200. The user inputs, for example, the following approved conditions:

Vehicle type: ordinary, Discount rate for coordination: 10%

Smoking: unacceptable, Discount rate for coordination: coordination is unacceptable

Ride sharing acceptability: acceptable, Discount rate for coordination: 10%

Earliness in departure time: 1-5 min., Discount rate for coordination: 10%

Lateness in departure time: 1-5 min., Discount rate for coordination: 10%

Earliness in arrival time: 1-5 min., Discount rate for coordination: 10%

Lateness in arrival time: 1-5 min., Discount rate for coordination: 10%

Note that, if approved conditions are already registered in the reservation management apparatus 300, the user need not input approved conditions.

The reservation transmission unit 210 generates reservation data which describes the user number and the reservation conditions input by the user and transmits the generated reservation data to the reservation management apparatus 300. If the user inputs approved conditions, the reservation transmission unit 210 also includes the approved conditions input by the user in the reservation data.

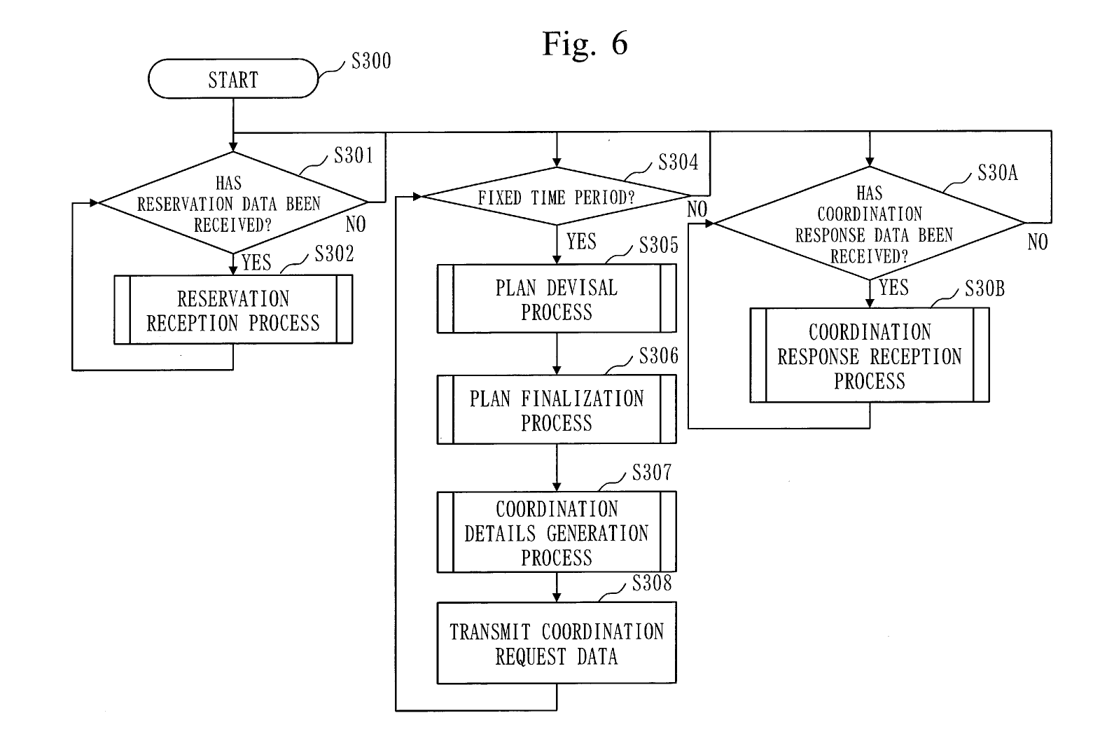

The overall operation of the reservation management apparatus 300 will next be described with reference to FIG. 6.

The reservation management control unit 310 activates, in parallel, a process of waiting to receive reservation data (step S301), a process of waiting for a fixed time period to elapse (step S304), and a process of waiting to receive coordination response data (step S30A), as separate processes.

When the reservation reception unit 311 receives reservation data from the reservation apparatus 200 in step S301, the reservation reception unit 311 performs a reservation reception process (step S302). After the performance of the reservation reception process (step S302), the reservation reception unit 311 waits again to receive reservation data in step S301.

In the reservation reception process (step S302), the reservation reception unit 311 mainly registers a user number and reservation conditions described in the reservation data in the reservation management table 371. The reservation reception unit 311 also registers approved conditions in the condition management table 381 if the reservation data includes the approved conditions.

When the fixed time period elapses in step S304, the plan devisal unit 320 performs a plan devisal process (step S305). Procedures in steps S304 to S308 loop.

In the plan devisal process (step S305) for a first time, the plan devisal unit 320 generates an operation plan (a service provision plan) using the reservation conditions and the approved conditions.

In the plan devisal process (step S305) for a second time or later, the plan devisal unit 320 updates the operation plan using an alternate condition accepted by a reserver.

In a plan finalization process (step S306), the plan finalization unit 321 finalizes an operation plan for a reservation a departure time of which is close at hand. In the plan finalization process (step S306), the plan finalization unit 321 mainly decides a final fare.

Note that the plan finalization unit 321 does not actually do anything for a reservation a departure time of which is not close at hand, in the plan finalization process (step S306).

A coordination details generation process (step S307) is performed for a reservation which is not finalized in the plan finalization process (step S306), that is, a reservation a departure time of which is not close at hand.

In the coordination details generation process (step S307), the coordination details generation unit 330 generates an alternate condition about which the reserver is to be queried.

In step S308, the coordination request transmission unit 350 transmits coordination request data which queries the reserver about whether the reserver accepts the alternate condition.

When the coordination request transmission unit 350 transmits the coordination request data, the plan devisal unit 320 waits again for the fixed time period to elapse (step S304).

If coordination response data is transmitted from the reservation apparatus 200 in response to the coordination request data transmitted in step S308, the coordination response reception unit 360 receives the coordination response data in step S30A, which will be described later. If the alternate condition is accepted by the reserver in the coordination response data, the plan devisal unit 320 updates an operation plan using the alternate condition accepted by the reserver in the plan devisal process (step S305) in a next iteration of the loop, as described earlier.

Until a departure time becomes close at hand, the procedures in steps S304 to S308 are repeated for one reservation.

When the coordination response reception unit 360 receives coordination response data in step S30A, the coordination response reception unit 360 performs a coordination response reception process (step S30B). In the coordination response reception process (step S30B), the coordination response reception unit 360 updates the coordination management table 386 and the coordination success rate management table 391.

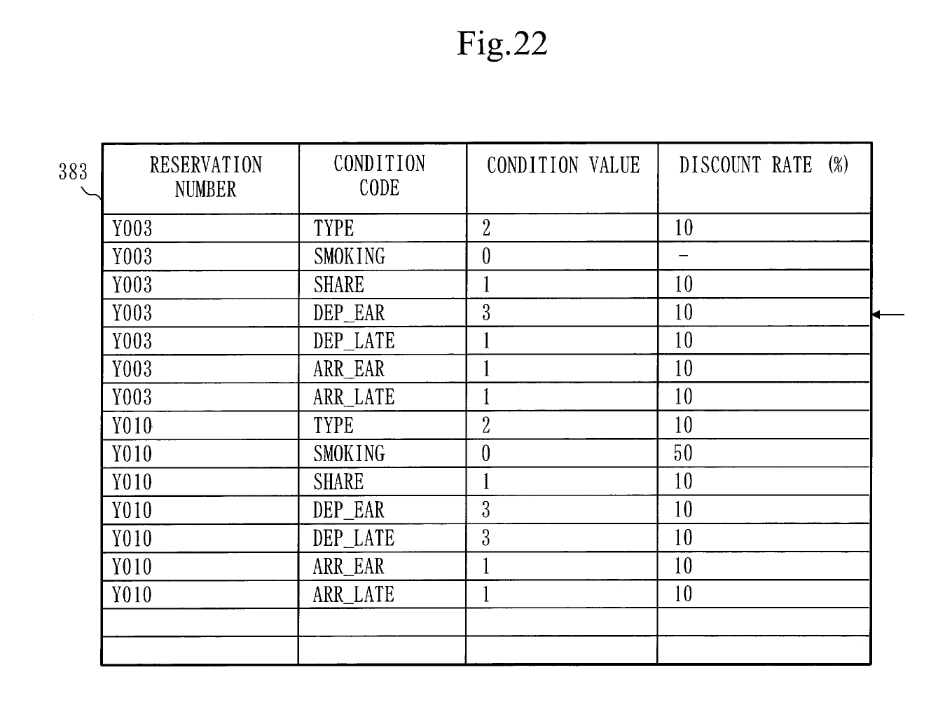

If an alternate condition is accepted by a reserver in the coordination response data, the coordination response reception unit 360 updates the condition management table 381 with the alternate condition. In the coordination response reception process (step S30B), for example, the condition management table 381 in FIG. 16 is updated to a condition management table 383 in FIG. 22. A condition value of “1” of a record, which is marked by an arrow, with a reservation number of “Y003” and a condition code of “DEP_EAR” in FIG. 16 has been updated to “4” in FIG. 22. That is, the example in FIG. 22 illustrates a case where the reserver has accepted an alternate condition with “DEP_EAR=3”.

After the performance of the coordination response reception process (step S30B), the coordination response reception unit 360 waits again to receive coordination response data (step S30A).

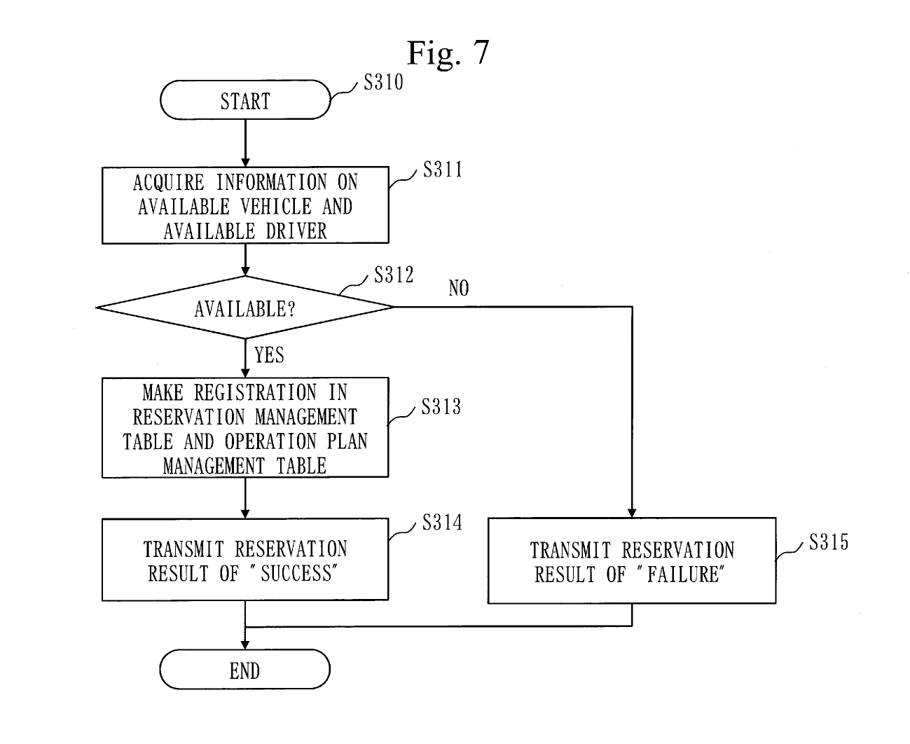

Details of the reservation reception process (step S302) in FIG. 6 will next be described with reference to FIG. 7.

The reservation reception unit 311 acquires information on an available vehicle and information on an available driver for reservation details in received reservation data, in step S311.

The reservation reception unit 311 determines in step S312 whether there are an available vehicle and an available driver.

The reservation reception unit 311 determines that there is an available vehicle, for example, if there is any vehicle that is not described in the operation plan management table 376 for a slot of time needed for an operation.

The reservation reception unit 311 determines that there is an available driver, for example, if there is any driver, duty hours of which overlap with the slot of time needed for the operation, and the driver is not described in the operation plan management table 376.

If at least either one of a vehicle and a driver is not secured (NO in step S312), the reservation reception unit 311 transmits reservation result data which gives notice of a reservation result of “failure” to the reservation apparatus 200 in step S315.

On the other hand, if both a vehicle and a driver are secured (YES in step S312), the reservation reception unit 311 registers a user number and reservation conditions which are described in the reservation data in the reservation management table 371 in step S313. The reservation reception unit 311 also registers the vehicle and the driver secured in step S312 in the operation plan management table 376.

The reservation reception unit 311 registers, for example, a record 372 in the reservation management table 371 in FIG. 14, in step S313. The reservation reception unit 311 also registers, for example, a record 377 in the operation plan management table 376 in FIG. 15 in step S313.

If the reservation data includes approved conditions, the reservation reception unit 311 registers the approved conditions in the condition management table 381 in FIG. 16, in step S313, as indicated by reference character 381a.

Referring back to the flow in FIG. 7, after step S313, the reservation reception unit 311 transmits reservation result data which gives notice of a reservation result of “success” to the reservation apparatus 200 in step S314 and ends the operation flow.

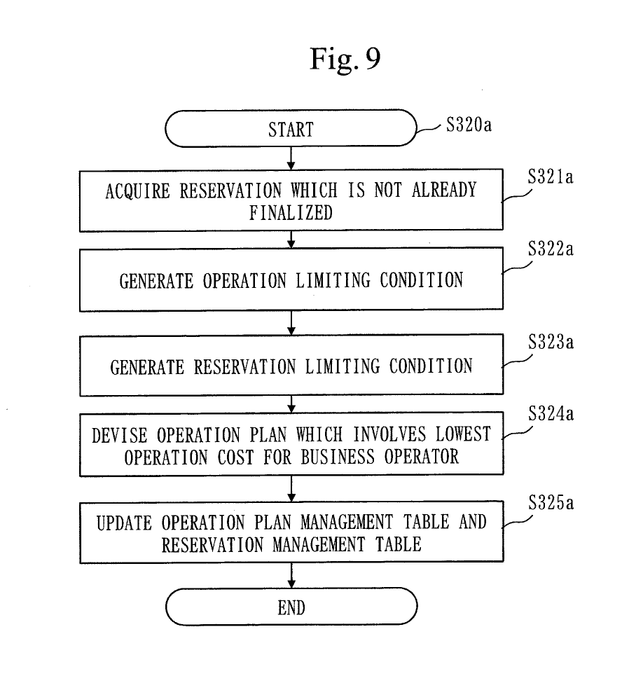

Details of the plan devisal process (step S305) will next be described with reference to FIG. 9.

In step S321a, the plan devisal unit 320 acquires a reservation which is not already finalized from the reservation management table 371. That is, the plan devisal unit 320 acquires, from the reservation management table 371, a record a “reservation status” of which does not have a value of “ALREADY FINALIZED”.

In step S322a, the plan devisal unit 320 generates operation limiting conditions. The operation liming conditions are limiting conditions required to devise a viable plan. The operation limiting conditions are, for example, limiting conditions which are obtained from the number of available vehicles, duty hours of available drivers, and the like.

In step S323a, the plan devisal unit 320 generates reservation limiting conditions. The reservation limiting conditions are limiting conditions which are obtained from the reservation conditions. For example, reservation limiting conditions concerning a departure time are expressed as follows:

Tdep(Yi)−Tdep_ear(Yi)≤Tdep(Yi,Vj)

Tdep(Yi)+Tdep_late(Yi)≥Tdep(Yi,Vj)

Here, Tdep(Y) represents a desired departure time of reservation Y. The plan devisal unit 320 uses, as Tdep(Y), a desired departure time described in the reservation management table 371.

Tdep_ear(Y) represents an amount of earliness in departure time which can be accepted by a reserver of reservation Y. The plan devisal unit 320 uses, as Tdep_ear(Y), a value of earliness in departure time included in approved conditions.

Tdep_late(Y) represents an amount of lateness in departure time which can be accepted by the reserver of reservation Y. The plan devisal unit 320 uses, as Tdep_late(Y), a value of lateness in departure time included in the approved conditions.

Tdep(Y,V) represents a time at which vehicle V is to depart from a departure point of reservation Y.

In step S324a, the plan devisal unit 320 devises an operation plan (a service provision plan) which involves a lowest operation cost for the business operator under the operation limiting conditions obtained in step S322a and the limiting conditions obtained in step S232a.

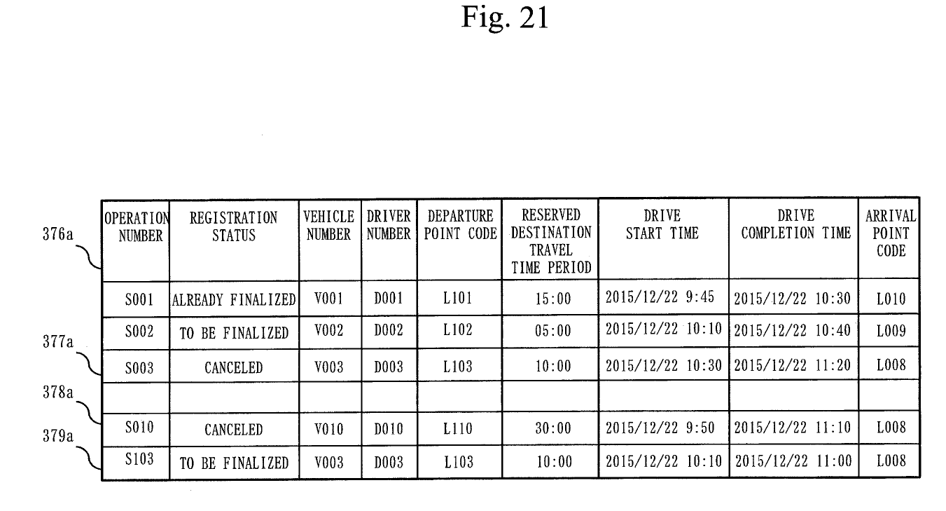

In step S325a, the plan devisal unit 320 updates the operation plan management table 376 in accordance with the latest operation plan obtained in step S324a. The plan devisal unit 320 updates, for example, the operation plan management table 376 in FIG. 15 to an operation plan management table 376a as in FIG. 21.

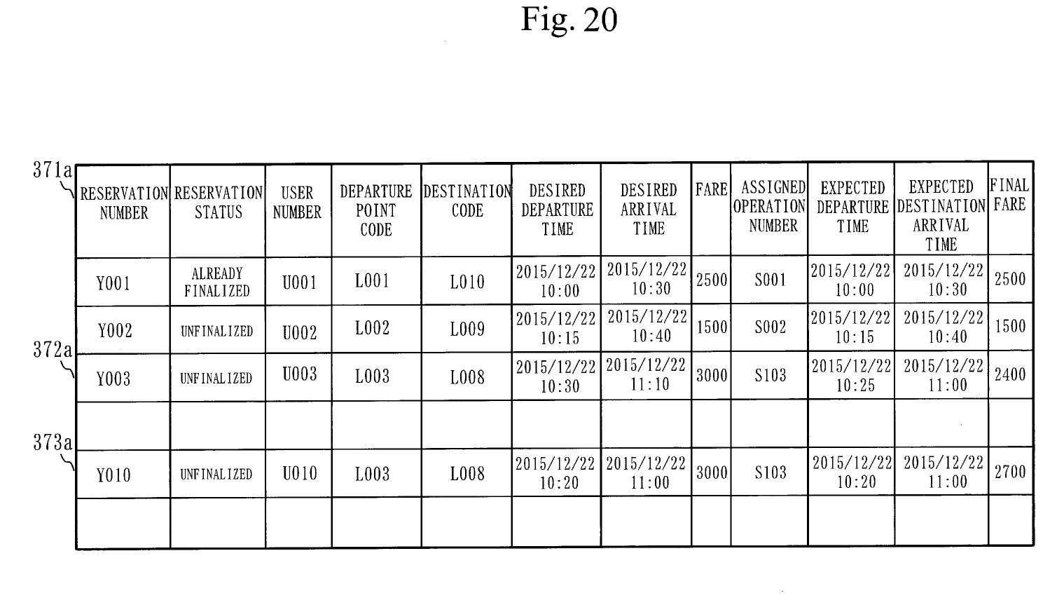

In step S325a, the plan devisal unit 320 updates the reservation management table 371 in accordance with the latest operation plan obtained in step S324a. The plan devisal unit 320 updates, for example, the reservation management table 371 in FIG. 14 to a reservation management table 371a in FIG. 20.

The examples in FIGS. 20 and 21 assume that ride sharing between the user with the user number of “U003” and a user with a user number of “U010” has been successfully coordinated. In FIG. 21, records 377a and 378a previously present in FIG. 15 have been canceled, and a record 379a corresponding to the ride sharing has been added instead. In FIG. 20, the record 372 and a record 373 previously present in FIG. 14 have been updated to records 372a and 373a so as to correspond to the record S379a in FIG. 21. The plan devisal unit 320 also updates a vehicle arrival time such that the vehicle arrival time corresponds to the ride sharing, as needed.

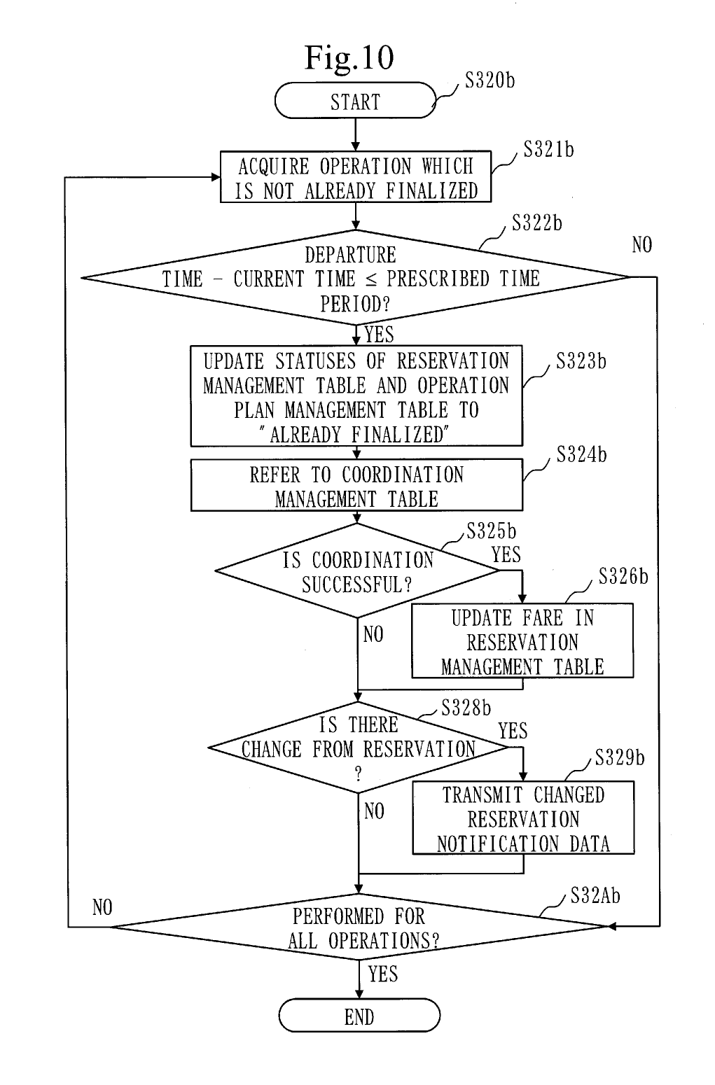

Details of the plan finalization process (step S306) will next be described with reference to FIG. 10.

In step S321b, the plan finalization unit 321 acquires an operation which is not already finalized from the operation plan management table 376a. That is, the plan finalization unit 321 acquires, from the operation plan management table 376a, a record a “registration status” of which does not have a value of “ALREADY FINALIZED”.

In step S322b, the plan finalization unit 321 determines whether a difference between a “departure time” of the record acquired in step S321b and a current time is not more than a prescribed time period.

If the difference between the “departure time” and the current time is more than the prescribed time period (NO in step S322b), the plan finalization unit 321 performs a process in step S32Ab. Details of step S32Ab will be described later.

On the other hand, if the difference between the “departure time” and the current time is not more than the prescribed time period (YES in step S322b), the plan finalization unit 321 updates a “registration status” for the corresponding operation in the operation plan management table 376a to “ALREADY FINALIZED” in step S323b. That is, the plan finalization unit 321 updates a “registration status” of the record in the operation plan management table 376a acquired in step S321b to “ALREADY FINALIZED”. The plan finalization unit 321 also updates a “reservation status” of a corresponding reservation in the reservation management table 371a to “ALREADY FINALIZED”. That is, the plan finalization unit 321 acquires a record in the reservation management table 371a which describes a value of an “operation number” of the record in the operation plan management table 376a, the “registration status” of which has been updated to “ALREADY FINALIZED”. The plan finalization unit 321 sets a “reservation status” of the acquired record to “ALREADY FINALIZED”.

In step S324b, the plan finalization unit 321 acquires a value of a “coordination status” for the corresponding reservation from the coordination management table 386.

That is, the plan finalization unit 321 acquires a record in the coordination management table 386 which describes a value of a “reservation number” of the record in the reservation management table 371a, a “reservation status” of which has been updated to “ALREADY FINALIZED”, in step S322b. The plan finalization unit 321 acquires the value of the “coordination status” of the acquired record.

In step S325b, the plan finalization unit 321 determines whether the “coordination status” is “SUCCESS”.

If the “coordination status” is “SUCCESS” (YES in step S325b), the plan finalization unit 321 performs a process in step S326b. On the other hand, if the “coordination status” is not “SUCCESS” (NO in step S325b), the plan finalization unit 321 performs a process in step S328b.

In step S326b, the plan finalization unit 321 updates a fare in the reservation management table 371a.

More specifically, the plan finalization unit 321 acquires, from the coordination management table 386 and the condition management table 381, a discount rate of a condition for which coordination is successful. That is, the plan finalization unit 321 acquires a “discount rate” of a record in the condition management table 381 which coincides in “reservation number” and “condition code” with the corresponding record in the coordination management table 386.

The plan finalization unit 321 further applies a value of the acquired “discount rate” to a “fare” of a record identical in “reservation number” in the reservation management table 371a to calculate a discounted fare. The plan finalization unit 321 registers the calculated discounted fare as a “final fare” in the reservation management table 371a.

For example, the plan finalization unit 321 acquires, from the condition management table 381 in FIG. 22, “discount rates” corresponding to a combination of “reservation number: Y003” and “condition code: SHARE” in a first row (coordination number: A001) and a combination of “reservation number: Y003” and “condition code: DEP_EAR” in a second row (coordination number: A002) in FIG. 18. The “discount rate” for the combination of “reservation number: Y003” and “condition code: SHARE” and the “discount rate” for the combination of “reservation number: Y003” and “condition code: DEP_EAR” are 10% and 10%, respectively, and the plan finalization unit 321 applies a total of 20% to an original fare of 3000 yen (a fare of the record 372a in FIG. 20). As a result, a “final fare” of the record 372a in FIG. 20 becomes 2400 yen.

Note that the plan finalization unit 321 may perform coordination such that a discount rate increases with a decrease in a response time period which is a difference between a “coordination request transmission time” and a “coordination response reception time” in the coordination management table 386 or a discount rate decreases with an increase in the response time period.

In step S328b, the plan finalization unit 321 determines, from the updated reservation management table 371a, whether there is a change from an original reservation. If there is a change on the reservation, the plan finalization unit 321 performs a process in step S329b.

On the other hand, if there is no change on the reservation, the plan finalization unit 321 performs a process in step S32Ab.

In step S329b, the plan finalization unit 321 transmits changed reservation notification data to the reservation change result reception unit 220 of the reservation apparatus 200.

In step S32Ab, the plan finalization unit 321 determines whether the processes in step S321b and the steps subsequent thereto are performed for all operations. If the processes in step S321b and the steps subsequent thereto are performed for all the operations, that is, if the processes in step S321b and the steps subsequent thereto are performed for all records in the operation plan management table 376a, the plan finalization unit 321 ends the operation flow.

On the other hand, if there is an operation for which the processes are not yet performed, the plan finalization unit 321 performs the process in step S321b.

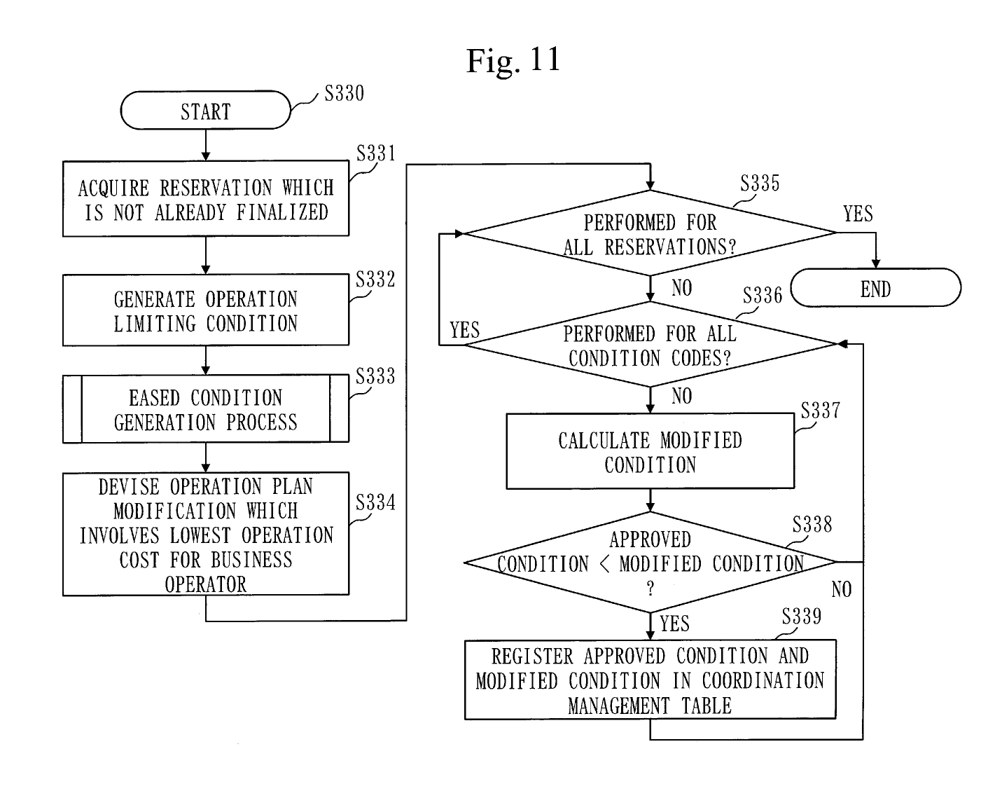

Details of the coordination details generation process (step S307) will next be described with reference to a flow in FIG. 11.

In step S331, the coordination details generation unit 330 acquires a reservation which is not already finalized from the reservation management table 371a. That is, the coordination details generation unit 330 acquires a record, a “reservation status” of which does not have a value of “ALREADY FINALIZED”, from the reservation management table 371a.

In step S332, the coordination details generation unit 330 generates operation limiting conditions. The process is the same as the process in step S322a in FIG. 9.

In step S333, the coordination details generation unit 330 performs an eased condition generation process. In the eased condition limitation generation process, the coordination details generation unit 330 generates an eased condition and generates a reservation limiting condition based on the eased condition.

Note that the term “ease” refers to limiting flexibility for a reserver and enhancing flexibility for the business operator. If condition B is an eased condition for condition A, condition B is a condition which is less in the flexibility for (more disadvantageous to) the reserver than condition A and is more in the flexibility for (more advantageous to) the business operator than condition A.

Specifically, a condition is more eased (the flexibility for the business operator increases) with an increase in a settable value in FIG. 17.

Note that details of the eased condition generation process (step S333) will be described later.

In step S334, the coordination details generation unit 330 devises a modification of an operation plan (a service provision plan) which involves a lowest operation cost for the business operator under the limiting conditions obtained in steps S332 and S333.

In step S335, the coordination details generation unit 330 determines whether processes in step S336 and steps subsequent thereto are performed for all reservations. That is, the coordination details generation unit 330 determines whether the processes in step S336 and the steps subsequent thereto are performed for all records in the reservation management table 371a.

If the processes in step S336 and the steps subsequent thereto are performed for all the reservations, the coordination details generation unit 330 ends the operation flow. If there is a reservation for which the processes in step S336 and the steps subsequent thereto are not performed, the coordination details generation unit 330 performs the processes in step S336 and the steps subsequent thereto for the reservation.

In step S336, the coordination details generation unit 330 refers to the condition management table 381 and determines whether processes in step S337 and steps subsequent thereto are performed for all condition codes for a corresponding reservation. If the processes in step S337 and the steps subsequent thereto are performed for all the condition codes, the coordination details generation unit 330 ends the operation flow. If there is a condition code for which the processes in step S337 and the steps subsequent thereto are not performed, the coordination details generation unit 330 performs the processes in step S337 and the steps subsequent thereto for the condition code.

In step S337, the coordination details generation unit 330 calculates a service provision condition (hereinafter referred to a modified condition) required to put the operation plan modification devised in step S334 into practice.

The modified condition is either one of (1) an eased condition and (2) an approved condition.

The eased condition is a condition which is generated in step S333.

In step S338, the coordination details generation unit 330 compares the approved condition with the modified condition.

If a value of the modified condition is larger than a value of the approved condition, that is, if the modified condition is a service provision condition which is more disadvantageous to a reserver than the approved condition and is more advantageous to the business operator, coordination is necessary, and the coordination details generation unit 330 performs a process in step S339.

On the other hand, if the value of the modified condition is not more than the value of the approved condition, coordination is unnecessary, and the coordination details generation unit 330 performs step S336 for an unprocessed reservation condition.

In step S339, the coordination details generation unit 330 registers the value of the modified condition in the coordination management table 386.

Specifically, the coordination details generation unit 330 registers the value of the approved condition as a “pre-coordination condition value” and the value of the modified condition as a “post-coordination condition value” in the coordination management table 386.

Note that, as described earlier, the coordination request transmission unit 350 generates coordination request data and transmits the generated coordination request data to the coordination request reception unit 230 of the reservation apparatus 200 in step S308 in FIG. 6. As for the coordination request data, a reserver being a user of the reservation apparatus 200 is notified of a modified condition as an alternate condition.

In the reservation apparatus 200, the coordination request reception unit 230 receives the coordination request data. The coordination request reception unit 230 then displays the alternate condition, notice of which is given through the coordination request data, on the display device 204.

The reserver inputs a coordination response to the reservation apparatus 200 using the input device 203.

The coordination response transmission unit 240 generates coordination response data to give notice of the coordination response from the reserver and transmits the generated coordination response data to the coordination response reception unit 360 of the reservation management apparatus 300.

Note that although the coordination details generation unit 330 performs the processes in step S334 and the steps subsequent thereto after step S333 in FIG. 11, the coordination details generation unit 330 may skip the processes in step S334 and the steps subsequent thereto. That is, the coordination details generation unit 330 may cause the coordination request transmission unit 350 to generate a coordination request message to give notice of an eased condition generated in step S333 as an alternate condition.

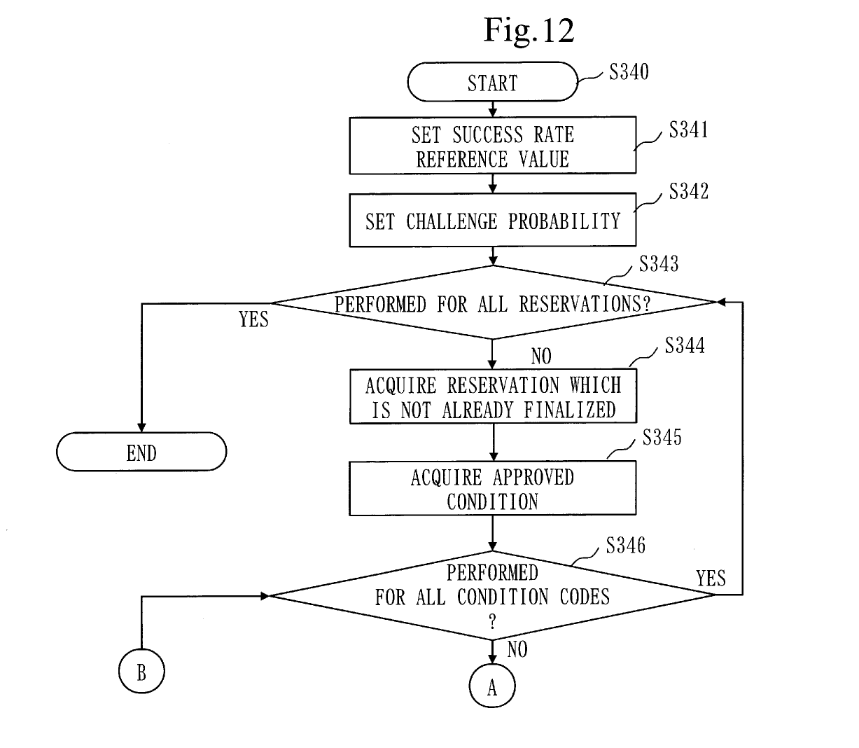

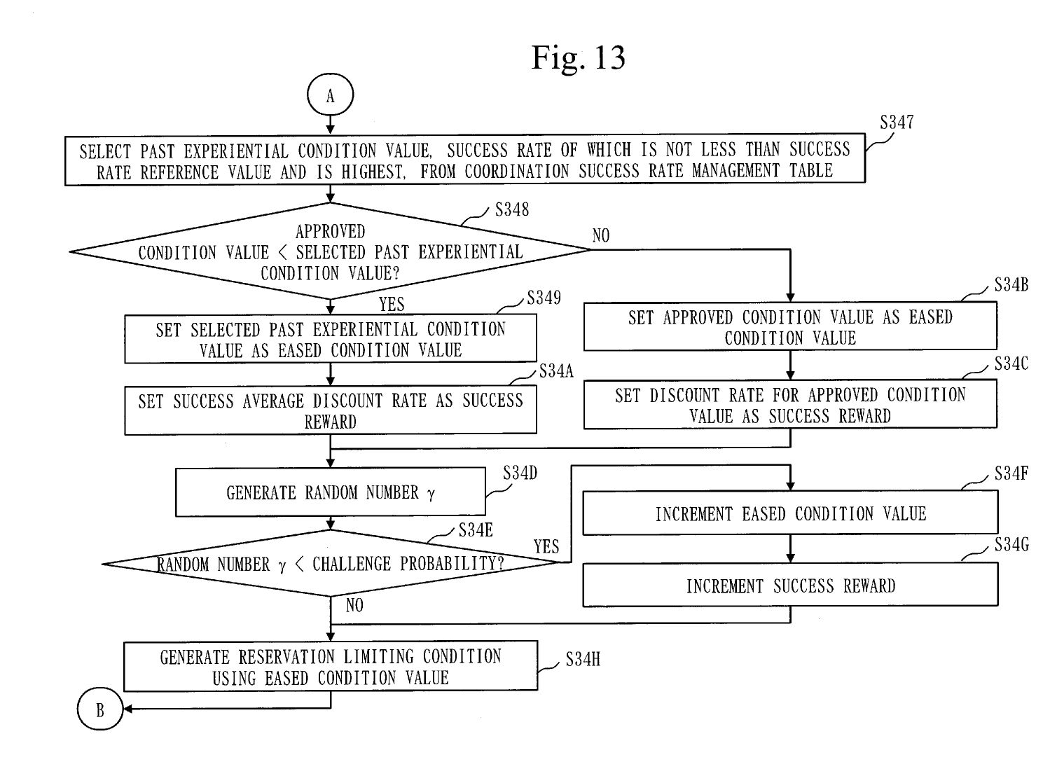

Details of the eased condition generation process (step S333) will next be described with reference to FIGS. 12 and 13.

In step S341, the coordination details generation unit 330 sets a success rate reference value. The success rate reference value is a success rate serving as a basis for selection of a past experiential condition from among a plurality of past experiential conditions.

Note that the coordination details generation unit 330 may perform step S341 once and can skip step S341 for a second time or later.

In step S342, the coordination details generation unit 330 sets a challenge probability. The challenge probability is a probability serving as a basis for determination as to whether to select a condition more eased than a selected past experiential condition.

Note that the coordination details generation unit 330 may perform step S342 once and can skip step S342 for a second time or later.

In step S343, the coordination details generation unit 330 determines whether processes in step S344 and steps subsequent thereto are performed for all reservations.

If the processes in step S345 and the steps subsequent thereto are performed for all the reservations (YES in step S343), the coordination details generation unit 330 ends the operation flow.

If there is a reservation for which the processes in step S344 and the steps subsequent thereto are not performed (NO in step S343), the coordination details generation unit 330 performs the process in step S344.

In step S344, the coordination details generation unit 330 acquires a reservation which is not “already finalized” from the reservation management table 371a. That is, the coordination details generation unit 330 acquires, from the reservation management table 371a, a record a “reservation status” of which does not have a value of “ALREADY FINALIZED”.

In step S345, the coordination details generation unit 330 acquires approved conditions. That is, the coordination details generation unit 330 acquires records in the condition management table 381 which describe a “reservation number” of the record acquired in step S344. The coordination details generation unit 330 acquires condition values which are described as “condition values” of the acquired records in the condition management table 381.

For example, if the record acquired in step S344 is the record 372a in FIG. 20, the coordination details generation unit 330 acquires a value of a “condition value” for each of “condition codes” of records in seven rows indicated by reference character 381a in FIG. 16. That is, the coordination details generation unit 330 acquires a value of a “condition value” in one row in step S345 each time.

In step S346, the coordination details generation unit 330 determines whether processes in step S347 and steps subsequent thereto are performed for all condition codes. That is, the coordination details generation unit 330 determines whether the processes in step S347 and the steps subsequent thereto are performed for all of the seven rows indicated by reference character 381a in FIG. 16.

If the processes in step S347 and the steps subsequent thereto are performed for all the condition codes (YES in step S346), the coordination details generation unit 330 performs the process in step S343 again.

If there is a condition code for which the processes in step S347 and the steps subsequent thereto are not performed (NO in step S346), the coordination details generation unit 330 performs the process in step S347 for the condition code.

In step S347, the coordination details generation unit 330 selects, from the coordination success rate management table 391, a past experiential condition, a success rate of which is not less than the success rate reference value and is the highest (most advantageous to the business operator), for the condition code in question.

The success rate reference value is a value set in step S341.

Assume that the coordination details generation unit 330 is currently performing step S347 for “DEP_EAR” in a fourth row in FIG. 16. Also, assume that the success rate reference value set in step S341 is 70%.

A “user number” corresponding to “reservation number: Y003” in the fourth row in FIG. 16 is “U003”, as can be seen from a third row (the record 372a) in FIG. 20.

The coordination details generation unit 330 selects a record (DEP_EAR=3) in a third row, a success rate of which is not less than the success rate reference value (=70%) and a past experiential condition value of which is the highest, from among records in four rows which describe “U003” and “DEP_EAR” in FIG. 19.

In step S348, the coordination details generation unit 330 compares the approved condition value with a value (hereinafter referred to as a selected past experiential condition value) of the past experiential condition selected in step S347.

If the selected past experiential condition value is larger than the approved condition value (YES in step S348), the coordination details generation unit 330 performs a process in step S349. On the other hand, if the selected past experiential condition value is not more than the approved condition value (NO in step S348), the coordination details generation unit 330 performs a process in step S34B. Since the selected past experiential condition value of “DEP_EAR=3” is larger than the approved condition value of “DEP_EAR=1” in FIG. 16, it is determined YES in step S348 in the example.

In step S349, the coordination details generation unit 330 sets the selected past experiential condition value as an eased condition value.

In step S34A, the coordination details generation unit 330 sets a success average discount rate in the coordination success rate management table 391 as a success reward. The success reward is a reward (a discount rate) which is given to a reserver if the reserver accepts the selected past experiential condition value.

In step S34B, the coordination details generation unit 330 sets the approved condition value as the eased condition value.

In step S34C, the coordination details generation unit 330 sets a discount rate for the approved condition value in the condition management table 381 as the success reward.

In step S34D, the coordination details generation unit 330 generates a random number γ.

In step S34E, the coordination details generation unit 330 compares the random number γ with the challenge probability set in the step S342. If the random number γ is smaller than the challenge probability (YES in step S34E), the coordination details generation unit 330 performs a process in step S34F. On the other hand, if the random number γ is not less than the challenge probability (NO in step S34E), the coordination details generation unit 330 performs a process in step S34H.

In step S34F, the coordination details generation unit 330 increments a value of the eased condition value set in step S349 or step S34B. As one example, it is conceivable that the coordination details generation unit 330 increments the value of the eased condition value by 1. For example, if the coordination details generation unit 330 sets the past experiential condition value (DEP_EAR=3) described earlier as the eased condition value in step S349, the coordination details generation unit 330 changes the eased condition value to “DEP_EAR=4” in step S34F.

Note that an increment may not be 1.

In step S34G, the coordination details generation unit 330 increments a value of the success reward set in step S34A or step S34C. As one example, it is conceivable that the coordination details generation unit 330 increments the value of the success reward by 10%. For example, if the coordination details generation unit 330 sets the past experiential condition value (DEP_EAR=3) described earlier as the eased condition value in step S349 and sets the success reward to 10% in step S34A, the coordination details generation unit 330 changes the success reward to 20% in step S34F.

Note that an increment may not be 10%.

In step S34H, the coordination details generation unit 330 generates a reservation limiting condition for the eased condition value, like step S323a in FIG. 9.

The coordination details generation unit 330 can select a past experiential condition more disadvantageous to a reserver than an approved condition and more advantageous to the business operator, as indicated in step S349 in FIG. 13. The coordination details generation unit 330 can also set the selected past experiential condition selected, as an eased condition. Additionally, the coordination details generation unit 330 can set a condition more disadvantageous to the reserver than the selected past experiential condition and more advantageous to the business operator as an eased condition, as indicated in step S34F in FIG. 13.

If a value of a modified condition is larger than a value of an approved condition in a case where the modified condition is an eased condition (YES in step S338 in FIG. 11), the coordination request transmission unit 350 generates coordination request data which gives notice of an eased condition generated by the procedure in step S333 (FIGS. 12 and 13) in FIG. 11 as an alternate condition.

That is, the coordination request transmission unit 350 generates coordination request data which gives notice of an eased condition more disadvantageous to a reserver than the approved condition and more advantageous to the business operator as an alternate condition. If the eased condition is accepted by the reserver, the plan devisal unit 320 updates an operation plan using the eased condition (step S324a in FIG. 9).

As illustrated in FIG. 6, the procedures in steps S304 to S308 are repeated for one reservation until a departure time becomes close at hand. For this reason, the process in step S333 in FIG. 11 may be performed a plurality of times for one reservation.

If an eased condition generated by the procedure in step S333 (FIGS. 12 and 13) is not more than an eased condition about which a reserver is already queried, the coordination details generation unit 330 performs the processes in S334 and the steps subsequent thereto for the newly generated eased condition in the following manner.

If the newly generated eased condition is identical to the eased condition about which the reserver is already queried, the coordination details generation unit 330 does not perform the processes in S334 and the steps subsequent thereto for the newly generated eased condition. This makes it possible to avoid repeatedly making a query about the same eased condition to the reserver.

On the other hand, if the newly generated eased condition is smaller than the eased condition about which the reserver is already queried, and the reserver has already accepted the eased condition about which the reserver is already queried, the coordination details generation unit 330 does not perform the processes in S334 and the steps subsequent thereto for the newly generated eased condition. This makes it possible to avoid making a query about an eased condition smaller than an eased condition accepted by the reserver. If the newly generated eased condition is smaller than the eased condition about which the reserver is already queried, and the reserver has already rejected the eased condition about which the reserver is already queried, the coordination details generation unit 330 performs the processes in S334 and the steps subsequent thereto for the newly generated eased condition. Since the newly generated eased condition is smaller than the rejected eased condition, the reserver may accept the newly generated eased condition.

If the newly generated eased condition is larger than the eased condition about which the reserver is already queried, the coordination details generation unit 330 performs the processes in S334 and the steps subsequent thereto for the newly generated eased condition.

For example, assume that the coordination details generation unit 330 has set an eased condition value to “DEP_EAR=4” in step S34F in the process in step S333 for a first time and that the coordination request transmission unit 350 has transmitted coordination request data which gives notice of “DEP_EAR=4” to the reservation apparatus 200 in step S308 in FIG. 6. If the coordination details generation unit 330 sets the eased condition value to “DEP_EAR=4” in step S34F in the process in step S333 for a second time, the coordination details generation unit 330 does not perform the processes in S334 and the steps subsequent thereto for “DEP_EAR=4”. If the coordination details generation unit 330 sets the eased condition value to “DEP_EAR=3” in step S34F in the process in step S333 for the second time, the coordination details generation unit 330 does not perform the processes in S334 and the steps subsequent thereto for “DEP_EAR=3” as long as a reserver has accepted “DEP_EAR=4”. On the other hand, if the reserver has rejected “DEP_EAR=4”, the coordination details generation unit 330 performs the processes in S334 and the steps subsequent thereto for “DEP_EAR=3”.

Assume that the coordination details generation unit 330 has set the eased condition value to “DEP_EAR=3” in the process in step S333 for the first time and that the coordination request transmission unit 350 has transmitted coordination request data which gives notice of “DEP_EAR=3” to the reservation apparatus 200 in step S308 in FIG. 6. If the coordination details generation unit 330 sets the eased condition value to “DEP_EAR=4” in step S34F in the process in step S333 for the second time, the coordination details generation unit 330 performs the processes in S334 and the steps subsequent thereto for “DEP_EAR=4”.

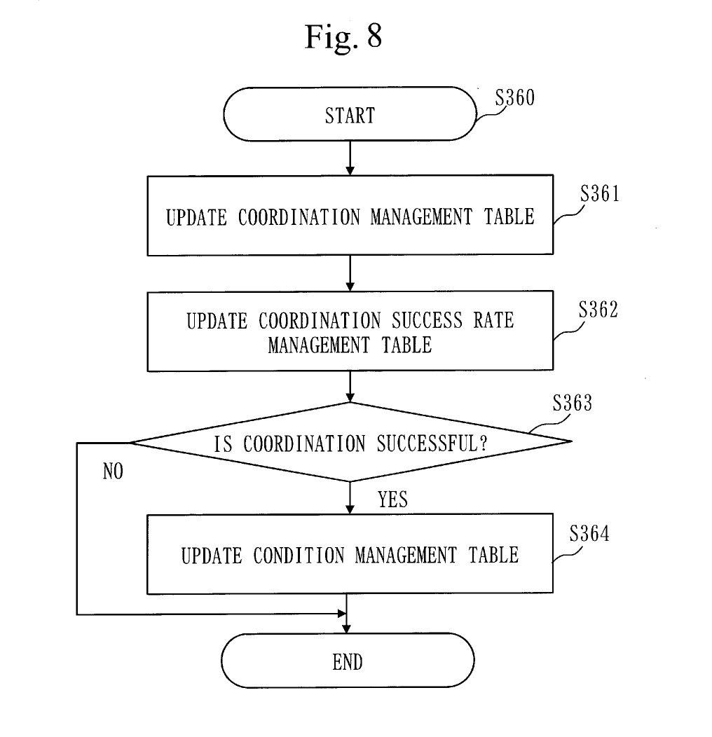

Finally, details of the coordination details reception process (step S30B) will be described with reference to FIG. 8.

In step S361, the coordination response reception unit 360 updates the coordination management table 386 on the basis of coordination response data received from the reservation apparatus 200.

Specifically, the coordination response reception unit 360 registers a response (acceptance/rejection) from a reserver, notice of which is given with the coordination response data, as a “coordination status” in the coordination management table 386. The coordination response reception unit 360 also registers a time of the reception of the coordination response data as a “coordination response reception time” in the coordination management table 386.

In step S362, the coordination response reception unit 360 updates the coordination success rate management table 391 on the basis of the coordination response data received from the reservation apparatus 200.

Specifically, the coordination response reception unit 360 increments a value of the “number of times of coordination” by 1. If the response from the reserver indicates acceptance, the coordination response reception unit 360 increments a value of the “number of successes” by 1. The coordination response reception unit 360 calculates a “coordination success rate”, a “success average discount rate”, and an “average response time period” and updates each value with the calculation results.

If the response from the reserver indicates acceptance (YES in step S363), the coordination response reception unit 360 updates the condition management table 381 with an alternate condition in step S364. That is, the coordination response reception unit 360 updates the condition management table 381 in FIG. 16 to, for example, the condition management table 383 in FIG. 22.

### Description of Advantageous Effects of Embodiment

As has been described above, in the present embodiment, the reservation management apparatus 300 generates an alternate condition which is a service provision condition not approved at the time of reservation by a reserver, more disadvantageous to the reserver than an approved condition, and more advantageous to the business operator than the approved condition, together with a reward. Additionally, if a response of intent to accept the alternate condition and the reward is obtained from the reserver, the reservation management apparatus 300 updates an operation plan using the alternate condition. For this reason, the present embodiment allows a change of an operation plan using a service provision condition not approved at the time of reservation by a reserver. It is thus possible to increase the satisfaction level of a reserver and increase benefits to the business operator.

In the present embodiment, the reservation management apparatus 300 generates an alternate condition, for which coordination is highly likely to succeed, on the basis of a coordination success rate in the past and updates an operation plan using the alternate condition. This allows an increase in the possibility of putting a most appropriate plan for a reserver and a business operator into practice.

In the present embodiment, even if all coordination tasks are not completed in time, the reservation management apparatus 300 can use an alternate condition for which coordination has been successful. For this reason, an operation plan desirable for a reserver and a business operator can be held, as compared to a case without coordination.

In the present embodiment, a success reward is set on the basis of a coordination success rate in the past. A reserver thus cooperates easily in coordination.

The present embodiment is set such that a success reward increases with an earlier response. Therefore, a reserver thus cooperates easily in coordination.

### REFERENCE SIGNS LIST

100: reservation system; 200: reservation apparatus; 201: processor; 202: memory; 203: input device; 204: display device; 205: communication device; 210: reservation transmission unit; 220: reservation change result reception unit; 230: coordination request reception unit; 240: coordination response transmission unit; 300: reservation management apparatus; 301: processor; 302: memory; 303: input device; 304: display device; 305: communication device; 306: storage; 310: reservation management control unit; 311: reservation reception unit; 320: plan devisal unit; 321: plan finalization unit; 330: coordination details generation unit; 350: coordination request transmission unit; 360: coordination response reception unit; 370: reservation management unit; 371: reservation management table; 375: operation plan management unit; 376: operation plan management table; 380: condition management unit; 381: condition management table; 382: condition code table; 383: condition management table; 385: coordination management unit; 386: coordination management table; 390: coordination success rate management unit; 391: coordination success rate management table; 800: network

1-7. (canceled)

8. A reservation management apparatus comprising:
processing circuitry to:
generate a plan for provision of a service to a reserver, using an approved condition that is a service provision condition approved at the time of reservation by the reserver of the service;
generate an alternate condition that is a service provision condition not approved at the time of the reservation by the reserver, more disadvantageous to the reserver than the approved condition, and more advantageous to a service provider than the approved condition, together with a reward that is given to the reserver if the reserver accepts the alternate condition; and
update the plan for the provision of the service to the reserver using the alternate condition if a response of intent to accept the alternate condition and the reward is obtained from the reserver as a result of making a query about whether the reserver accepts the alternate condition and the reward.

9. The reservation management apparatus according to claim 8, wherein
the processing circuitry generates the alternate condition on the basis of a past experiential condition that is a service provision condition, about which the reserver has previously been queried.

10. The reservation management apparatus according to claim 9, wherein
the processing circuitry
refers to past experiential condition information that describes a plurality of past experiential conditions and a success rate for a response to a query addressed to the reserver for each of the plurality of past experiential conditions,
selects a past experiential condition, a success rate of which is not less than a threshold, from among the plurality of past experiential conditions, and
generates the alternate condition on the basis of the selected past experiential condition selected.

11. The reservation management apparatus according to claim 10, wherein
the processing circuitry selects a past experiential condition, a success rate of which is not less than the threshold and which is most advantageous to the service provider, from among the plurality of past experiential conditions.

12. The reservation management apparatus according to claim 10, wherein
the processing circuitry generates, as the alternate condition, a service provision condition that is more disadvantageous to the reserver than the selected past experiential condition and is more advantageous to the service provider.

13. A reservation management method comprising:
generating a plan for provision of a service to a reserver, using an approved condition that is a service provision condition approved at the time of reservation by the reserver of the service;
generating an alternate condition that is a service provision condition not approved at the time of the reservation by the reserver, more disadvantageous to the reserver than the approved condition, and more advantageous to a service provider than the approved condition, together with a reward that is given to the reserver if the reserver accepts the alternate condition; and
updating the plan for the provision of the service to the reserver using the alternate condition if a response of intent to accept the alternate condition and the reward is obtained from the reserver as a result of making a query about whether the reserver accepts the alternate condition and the reward.

14. A non-transitory computer readable medium storing a reservation management program that causes a computer to execute:
a plan generation process of generating a plan for provision of a service to a reserver, using an approved condition that is a service provision condition approved at the time of reservation by the reserver of the service;
a condition generation process of generating an alternate condition that is a service provision condition not approved at the time of the reservation by the reserver, more disadvantageous to the reserver than the approved condition, and more advantageous to a service provider than the approved condition, together with a reward that is given to the reserver if the reserver accepts the alternate condition; and
a plan updating process of updating the plan for the provision of the service to the reserver using the alternate condition if a response of intent to accept the alternate condition and the reward is obtained from the reserver as a result of making a query about whether the reserver accepts the alternate condition and the reward.
